(19) United States
(12) Patent Application Publication
(10) Pub. No.: US 2016/0031068 A1
(43) Pub. Date: Feb. 4, 2016

(54) SCREW HOLDING DEVICE AND SCREWDRIVER

(71) Applicant: Positec Power Tools (Suzhou) Co., Ltd, Suzhou (CN)

(72) Inventors: Yichun MA, Suzhou (CN); Jingtao XU, Suzhou (CN); Shisong ZHANG, Suzhou (CN)

(21) Appl. No.: 14/885,276

(22) Filed: Oct. 16, 2015

Related U.S. Application Data
(63) Continuation of application No. PCT/CN2014/075469, filed on Apr. 16, 2014.

(30) Foreign Application Priority Data
Apr. 16, 2013 (CN) 201310131642.0

(51) Int. Cl. B25B 23/10; B25B 21/00; B25B 23/00

(52) U.S. Cl. CPC B25B 23/10; B25B 23/005; B25B 21/00

(57) ABSTRACT

A screw holding device configured to assist a screwdriver in holding a screw, the screwdriver providing rotary power output to the screw, the screw holding device comprising: a body capable of being connected with the screwdriver; a holder connected with the body and comprising at least two clamping arms configured to move between a clamp position wherein the screw is clamped and a release position wherein the screw is released; and a driving mechanism configured to drive the clamping arms and comprising a guide unit and a connection unit. The connection unit is in correspondence to the clamping arms and comprises first and second connectors respectively connected with the clamping arms. The guide unit drives the first connector to move longitudinally and laterally, and drives the second connector to move at least longitudinally, so as to drive the clamping arms to produce pivotal motion and longitudinal linear motion.

### CROSS-REFERENCE TO RELATED APPLICATION

This application is a continuation of International Patent Application No. PCT/CN2014/075469, filed on Apr. 16, 2014, which in-turn claims priority to Chinese Patent No. 201310131642.0, filed on Apr. 16, 2013, the contents of which are incorporated herein by reference.

### BACKGROUND

1. Technical Field

The present invention relates to a screw holding device and a screwdriver.

2. Related Art

In people's daily life, tightening the screws is very common and can be applied to many occasions. At present, there are several common methods of driving a screw into a workpiece, and one way is to drive the screw into the workpiece by using a hand tool, in which the hand tool may be a slot-type screwdriver, a Philip's type screwdriver or the like. However, such a method has many shortcomings, and the hand tool cannot provide an additional torque and can only rely on workers to provide a torque by themselves, which will consume lots of physical strength of the workers. In addition, the rotation speed of the hand tool is very low, so that the time it takes to drive the screw into the workpiece is greatly extended, which reduces the workers' efficiency.

Another way is to drive the screw into the workpiece by using an electric tool, in which the electric tool may be a screwdriver, an electric drill or the like. The electric tool uses electric power to drive the motor to output mechanical power, which can thus usually obtain a higher torque and a faster speed. The workers' physical strength and time can be saved greatly. However, in the process of driving the screw, it is very easy to deviate from the normal direction, and the workers have to manually centralize the screw to drive the screw. This brings about great inconvenience to the workers. For this point, people have come up with some methods to avoid that the screw tilts in the driving process. For example, U.S. Pat. No. 8,047,100B2 discloses a screw support device, but such a screw support device has a telescoping leg which is provided thereon with a magnetic structure and can adsorb and support a screw; however, such a device cannot support the screw stably, and at the time of work, the screw is highly susceptible to shake, which results in that the screw cannot be precisely driven into the workpiece. For another example, Chinese Patent No. CN2205766Y discloses a screw clamping device consisting of hook reeds. However, the screw clamping device has a greater volume and has a smaller clamping force for the screw, and the screw is very easy to fall off from the clamping device or a situation where the screw tilts occurs, which brings about inconvenience to the driving process and cannot really improve the work efficiency.

### SUMMARY

In view of this, an objective of the present invention is to provide a compact-sized screw holding device.

The technical solution put forward by the present invention to address the technical problems is as follows: a screw holding device, configured to assist a screwdriver in holding a screw, the screwdriver is configured to provide rotary power output to the screw, the screw holding device comprising: a body capable of being connected with the screwdriver; a holder connected with the body, the holder comprising at least two clamping arms being configured to move between a clamp position wherein the screw is clamped and a release position wherein the screw is released; and a driving mechanism configured to drive the clamping arms moving; wherein the driving mechanism comprises a guide unit and a connection unit, the connection unit is in correspondence to the clamping arm, the connection unit comprises a first connector and a second connector which are respectively connected with the clamping arm, the guide unit drives the first connector to move longitudinally and laterally, and the guide unit drives the second connector to move at least longitudinally, so as to drive the clamping arms to produce pivotal motion and longitudinal linear motion.

Preferably, the guide unit drives the first connector to move longitudinally and laterally at the same time, so as to drive the clamping arms to move pivotally.

Preferably, the guide unit comprises a first chute, the first chute comprises a first inclined portion which is inclined relative to the longitudinal direction along a first direction, an angle formed by a line linking the first connector with the second connector and the longitudinal direction is changed by movement of the first connector in the first inclined portion.

Preferably, the first chute further comprising a first extending portion, first extending portion extends longitudinally and is in communication with the first inclined portion.

Preferably, the first inclined portion is configured as a straight slot, an inclination angle between the straight slot and the first extending portion is about 0-45 degrees.

Preferably, the guide unit further comprises a second chute that guides the second connector to move longitudinally.

Preferably, the second chute comprises a second extending portion which extends longitudinally and a second inclined portion which is in communication with the second extending portion, the second inclined portion is inclined with respect to the longitudinal direction along a second direction which is opposite to the first direction, and an opening formed between the first inclined portion and the second inclined portion, width of the opening becomes larger along the direction towards a longitudinal front end.

Preferably, the first chute and the second chute are located on the body.

Preferably, a starting end of the first chute and a starting end of the second chute are spaced apart along the longitudinal axis.

Preferably, the driving mechanism further comprises a moving part and a biasing mechanism, the moving part has a through hole coupled with the first connector, and the biasing mechanism biases the moving part longitudinally, so that the first connector is movable longitudinally relative to the body.

Preferably, the biasing mechanism comprises a spring located between the moving part and the body.

Preferably, the through hole is a waist-shaped hole which is perpendicularly arranged relative to the longitudinal axis.

Preferably, the driving mechanism further comprises an abutting block connected with the moving part, a first longitudinal distance which is a distance between a longitudinal front end of the abutting block and a longitudinal rear end of the body is larger than a second longitudinal distance which is a distance between a longitudinal front end of the holder and the longitudinal rear end of the body.

Preferably, the screwdriver defines a vertical plane that passes through the longitudinal axis, the clamping arms comprises a pair of arms which are symmetrically disposed about the vertical plane.

Preferably, the clamping arms respectively comprise a coupling portion disposed along a longitudinal direction and a holding portion disposed perpendicular to the longitudinal direction, and the coupling portion is provided with a mating hole for fixedly coupling the first connector with the second connector.

Preferably, the number of the clamping arms is two and the clamping arms are symmetrically disposed about the longitudinal axis.

In addition, the present invention is also directed towards a screwdriver, used to provide rotary power output to a screw, the screwdriver comprising a housing and a motor located in the housing, the motor providing rotary power output, wherein the screwdriver further comprises the screw holding device described above.

Preferably, the screw holding device is detachably connected with the screwdriver.

Preferably, the screw holding device is detachably installed to the housing of the screwdriver through a mating mechanism, the mating mechanism comprises a elastic clamper, a slot located in the housing and accommodated with the elastic clamper, and an abutting portion located in the body, wherein longitudinal movement of the body makes the abutting portion shape matting with the elastic c.

Preferably, the body and the housing are further respectively provided with a guide portion for guiding the body and the housing to move longitudinally with respect to each other.

Preferably, the screw holding device is detachably installed to the housing of the screwdriver through a mating mechanism, the mating mechanism comprises an elastic part and a pressing block, the elastic part is located between the housing and the screw holding device and capable of providing an elastic force that biases the screw holding device, and wherein the pressing block abuts against the screw holding device and limits release of the elastic force of the elastic part.

Preferably, one of the pressing block and the screw holding device is provided with a flange projecting, and the other one of the pressing block and the screw holding device is provided with a recessed portion matched with the flange projecting.

Preferably, the screwdriver comprises an output shaft, a transmission, a tool bit support which is disposed in the housing, and a connecting shaft; the output shaft is provided with a receiving hole disposed axially to accommodate a tool bit; the transmission is configured to transmit rotary power output by the motor to the output shaft; the tool bit support is provided with several chambers arranged in parallel which are used to support the tool bit; and the connecting shaft is capable of making the tool bit to be located at a work position in the chambers or a receiving position in the tool bit support.

Compared with the prior art, beneficial effects of the present invention are as follows: in the process that the clamping arms of the screw holding device rotates from the clamp position to the release position, the clamp arms need to rotate a smaller angle, the rotation speed of the clamping arms are faster within the same stroke of movement, and by use of rapid rotation, the volume of the screw holding device is more compact, which adapts to more types of screwdrivers.

### BRIEF DESCRIPTION OF THE DRAWINGS

The objective, technical solution, and beneficial effects of the present invention described above can be clearly obtained through the following detailed description about specific embodiments that can implement the present invention and in combination with the description about the accompanying drawings.

The same marks and signs in the drawings and the specification are used to represent the same or equivalent element.

FIG. 1 is a schematic diagram when a screwdriver including a screw holding device does not clamp a screw according to one embodiment of the present invention.

FIG. 2 is a schematic diagram when the screwdriver in FIG. 1 is in a release position when clamping the screw.

FIG. 3 is a schematic diagram when the screwdriver in FIG. 1 is in a clamp position when clamping the screw.

FIG. 4 is an exploded schematic diagram of the screw holding device of the screwdriver in FIG. 1.

FIG. 5 is an exploded schematic diagram of a screw clamping device of a screwdriver according to another embodiment of the present invention.

FIG. 6 is a schematic diagram of a moving part of the screwdriver in FIG. 1 along one angle.

FIG. 7 is a schematic diagram of the moving part of the screwdriver in FIG. 1 along another angle.

FIG. 8 is a sectional diagram of the screwdriver in FIG. 1 from which the screw holding device is removed.

FIG. 9 is a schematic diagram of a screwdriver mating a screw clamping device according to another embodiment of the present invention.

FIG. 10 is a schematic diagram of cooperation between the elastic part and the pressing block in the mating mechanism in FIG. 9.

FIG. 11 is a detailed schematic diagram of the elastic part in the mating mechanism in FIG. 9.

FIG. 12 is a schematic diagram of one angle of the screw holding device in FIG. 9.

FIG. 13 is a schematic diagram of another angle of the screw holding device in FIG. 9.

### DETAILED DESCRIPTION

Preferred embodiments of the present invention are elaborated below with reference to the accompanying drawings, to enable advantages and features of the present invention to be understood by those skilled in the art more easily, thus making clearer definition to the protection scope of the present invention.

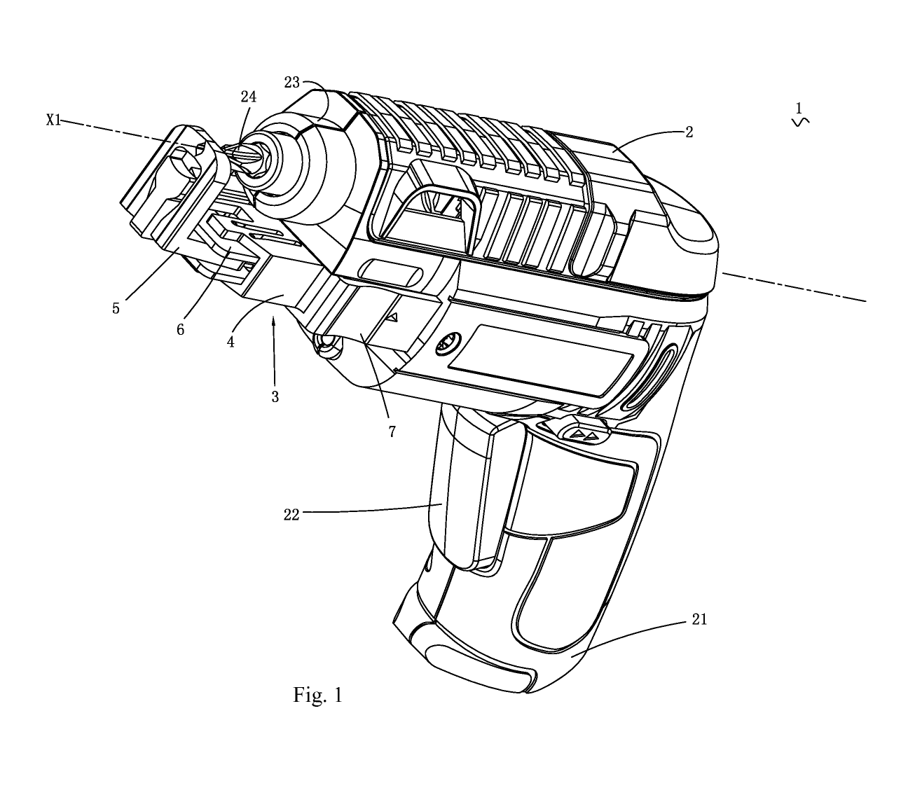

FIG. 1 to FIG. 8 show a screwdriver 1 according to one embodiment of the present invention. The screwdriver herein may be a screwdriver that belongs to an electric tool and may also be a hand tool. In this embodiment, the screwdriver 1 includes a housing 2. The housing 2 substantially extends along a direction of a work axis X1. The housing 2 contains a motor (not shown) therein. The motor is used to produce rotary output about the work axis X1. The screwdriver further includes a handle 21 for holding. The handle 21 extends along a direction deviating from the axis, so that the screwdriver 1 is pistol-shaped wholly. The handle 21 is provided thereon with a switch 22 used to turn on or turn off the motor. The housing 2 further contains a transmission mechanism (not shown) power-connected with the motor therein, and the transmission mechanism is used to transfer the rotary output to a working end 23 of the screwdriver 1. The working end 23 and the handle 21 are located at two corresponding sides of the screwdriver 1. In order to facilitate the description, the extending direction of the work axis X1 is defined as a longitudinal direction. One side of the screwdriver 1 along the work axis X1 and towards the working end 23 is defined as a front side (the left side in FIG. 1), and one side of the screwdriver 1 along the work axis X1 and towards the handle 21 is defined as a rear side (the right side in FIG. 1). At the same time, a plane which passes through the work axis X1 and divides the screwdriver 1 into two symmetrical halves is defined as a vertical plane. The screwdriver 1 includes a tool bit 24 located at the front side. The tool bit 24 is used to abut against a screw 100. The tool bit 24 may be selectively mounted on the working end 23. The tool bit 24 extends along the work axis X1 and has a contact surface in contact with the screw 100. The tool bit 24 is driven by the motor to make rotary motion around the work axis X1, so as to transfer the rotary output to the screw 100.

In this embodiment, the working end 23 further provides a screw holding device 3. The screw holding device 3 is used to assist in positioning the screw 100, to make the screw 100 stably abut against the tool bit 24, and to make the central axis of the screw located in the work axis X1, that is, a longitudinal axis. The screw holding device 3 mainly includes a body 4 fixedly connected to the screwdriver 1, a clamping mechanism 5 that directly clamps and contacts the screw 100 and a driving mechanism 6 that drives the clamping mechanism 5.

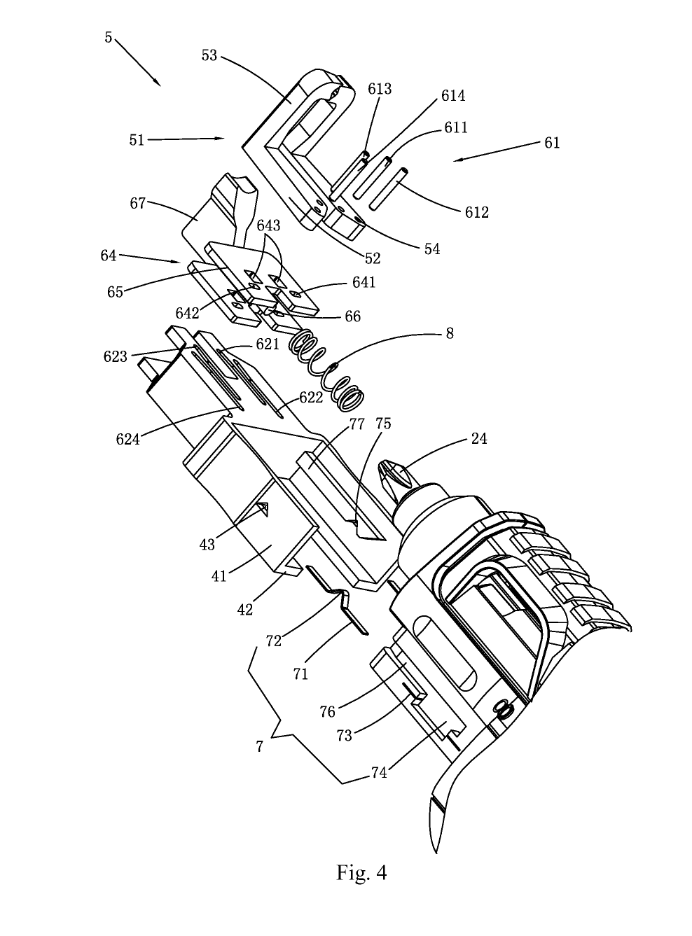

The body 4 is connected onto the housing 2 of the screwdriver 1 through a mating mechanism 7. Moreover, due to existence of the mating mechanism, the screw holding device 3 can be fixedly connected onto the screwdriver 1, which facilitates clamping of the screw 100 at the time of working of the screwdriver 1. When it is necessary to remove the screw holding device 3 from the screwdriver 1, the body 4 can be conveniently and rapidly separated from the housing 2. In this embodiment, as shown in FIG. 4 to FIG. 7, the mating mechanism 7 includes an elastic clamper 71 located between the body 4 and the housing 2. The middle of the elastic clamper 71 provides a projection 72 protruding beyond two ends. The projection 72 is substantially triangular, and two sides of the projection 72 are smooth bevel edges, which facilitate mating. In a preferred embodiment, the projection 72 may further have a smooth chamfer to further facilitate mating. The elastic clamper 71 may be made of a metal elastic material. In addition, the mating mechanism 7 further includes a slot 73 located on the housing 2 and accommodating the elastic clamper 71. The slot 73 is located at the working end 23 of the screwdriver 1, and is disposed in a position deviating from the work axis X1. As shown in FIG. 4, an inwardly concave region 74 is inwardly formed on the housing 2 located at the working end 23, and a slot 73 is opened on a side wall where the inwardly concave region 74 is formed. During installation, the projection 72 in the center of the elastic clamper 71 is just located in the inwardly concave region 74, while two ends of the elastic clamper 71 are just inserted into the slot 73. It should be noted that the housing 2 has two such inwardly concave regions 74, which are symmetrically disposed about the work axis X1. Each inwardly concave region 74 is provided with a slot 73 and an elastic clamper 71 installed in the slot 73. The body 4 is correspondingly provided thereon with an abutting portion 75 used to abut against the elastic clamper 71. In this embodiment, the abutting portion 75 is outwardly convex, and matches the shape of the projection 72. After the body 4 moves relative to the housing 2, the abutting portion 75 abuts against the projection 72 on the corresponding elastic clamper 71, and under the action of the elastic force of the elastic clamper 71, the body 4 is fixedly connected with the housing 2. When it is necessary to remove the body 4 from the housing 2, it is only necessary to apply a force that overcomes elastic force of the elastic clamper 71 to make the abutting portion 75 not abut against the projection 72, and removal can be completed. Certainly, it is also feasible to dispose the slot 73 on the body 4 and dispose the abutting portion 75 on the housing 2. In a preferred embodiment, the body 4 and the housing 2 are further provided thereon with guide portions that guide them to move relative to an axial direction. Specifically, the guide portion on the housing 2 is a groove 76, and the guide portion on the body 4 is a cord 77 that can be stuck into the groove 76. The groove 76 and the cord 77 both extend along the work axis X1, so that the body 4 performs mating in a manner of moving axially relative to the housing 2. In other embodiments, the positions of the groove 76 and the cord 77 are interchangeable.

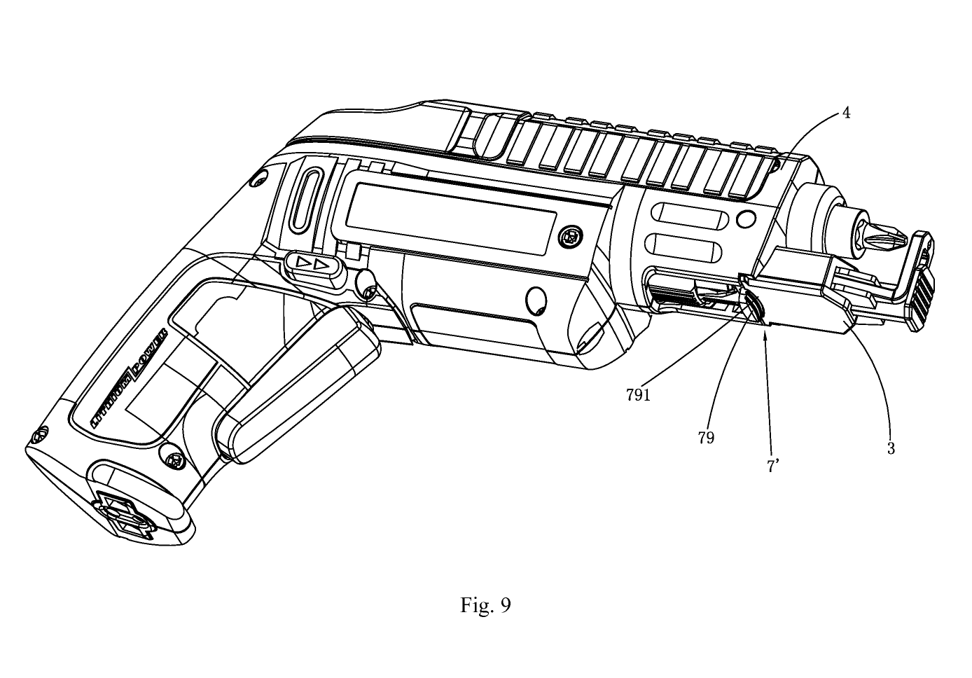

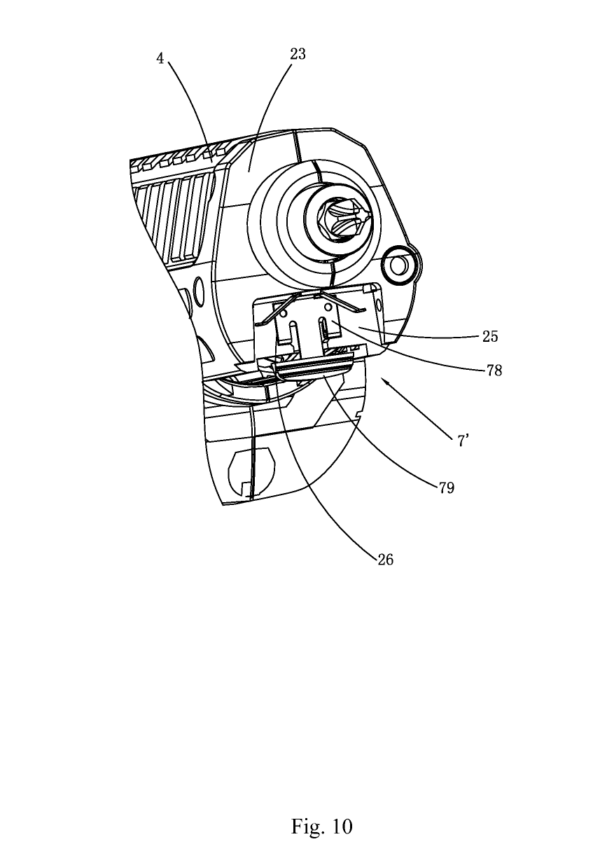

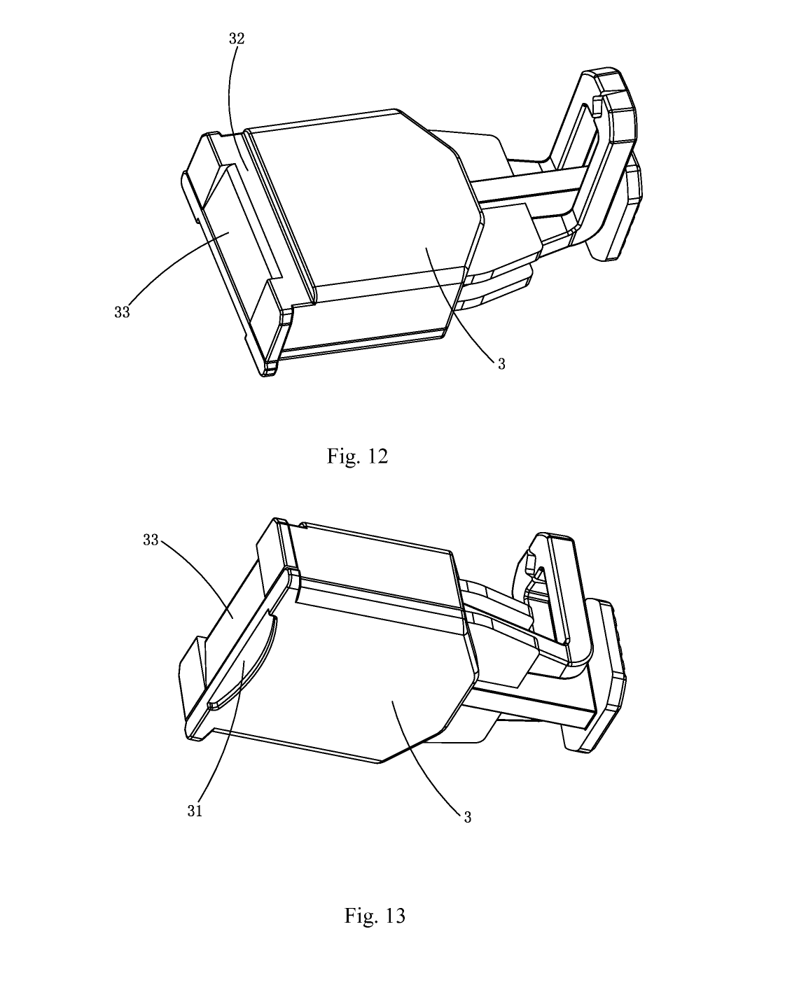

FIG. 9 to FIG. 13 show a mating structure 7′ according to another embodiment. The mating structure 7′ also makes the screw holding device 3 detachably installed on the housing 2 of the screwdriver 1. The mating structure 7′ mainly includes an elastic part 78 and a pressing block 79. The elastic part 78 is located between the housing 2 and the screw holding device 3. The elastic part 78 provides an elastic force that biases the screw holding device 3, and the pressing block 79 abuts against and limits the elastic part 78 to stop release of the elastic force of the elastic part 78. In this way, the screw holding device 3 is fixedly installed on the housing 2. When removal is required, the pressing block 79 is operated to move to get rid of the limiting effect, so that the elastic force of the elastic part 78 is released, thus driving the screw holding device 3 to be separated from the housing 2.

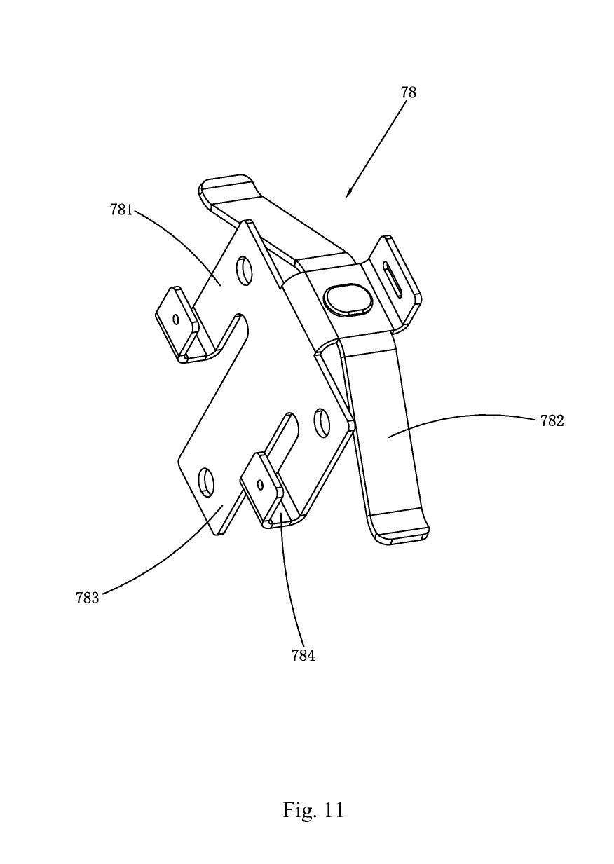

As shown in FIG. 11, the elastic part 78 includes an installation portion 781 fixedly installed on the housing 2, a first elastic portion 782 cooperating with the screw holding device 3 and a second elastic portion 783 cooperating with the pressing block 79. The installation portion 781 is fixedly connected with the housing 2. In this embodiment, the housing 2 has a chamber 25 hollowly formed. The chamber 25 is located at a vertical lower side of the working end 23 of the housing 2. Chamber walls 26 are disposed around the chamber 25. The installation portion 781 is located in the chamber 25. The installation portion 781 is specifically embodied as two installation arms, on which arc-shaped locking structures 784 are preferably disposed. The locking structures 784 and the chamber walls 26 in the chamber 25 play a role of clamping. It can be seen in the figure that the installation arms of the installation portion 781 are further provided with openings thereon. The openings can mate the screw to further improve reliability of the mating, and may also not be installed, and the openings are merely used for facilitating machining. In addition, the installation portion 781 may not be elastic, and be manufactured with a rigid material. The first elastic portion 782 is connected with the installation portion 781. In this embodiment, the first elastic portion 782 is substantially in a splay pattern, and has two elastic arms angle-interlocked. One end of each elastic arm is connected with the installation portion 781, preferably connected in a manner of integrated molding. The other end of the elastic arm is a free end, and the free end abuts against the body 4. The direction in which the first elastic portion 782 biases the body 4 is perpendicular to the direction of the work axis X1, which includes a vertical direction and may also be another direction. In addition, the direction in which the first elastic portion 782 biases the body 4 is also different from the direction in which the second elastic portion 783 mates the pressing block 79. The second elastic portion 783 is substantially an elastic arm, one end of the elastic arm is fixedly connected with the installation portion 781, and the other end of the elastic arm is connected with the pressing block 79. Movement of the pressing block 79 makes the elastic arm produce certain resetting elasticity.

The pressing block 79 has a certain thickness. The pressing block 79 has a mating portion 791 mating the screw holding device 3. After the screw holding device 3 is installed in place, it can abut against the mating portion 791, making the mating portion 791 produce a resetting elastic force that resists the second elastic portion 783. The mating portion 791 and the screw holding device 3 are in a relationship of surface abutment. In this embodiment, the mating portion 791 is a flange projecting on the pressing block 79. A recessed portion 31 matching the shape of the mating portion 791 is disposed in a corresponding position of the screw holding device 3. Certainly, in different embodiments, the positions of the recessed portion 31 and the mating portion 791 are interchangeable. When the mating portion 791 of the pressing block 79 cooperates with the recessed portion 31, the pressing block 79 plays a role of overcoming the acting force of the elastic part 78 to lock the screw holding device 3. When the mating portion 791 of the pressing block 79 is operated to be separated from the recessed portion 31, the acting force of the elastic part 78 correspondingly drives the screw holding device 3 to move to be disconnected from the screwdriver 1. In addition, the screw holding device 3 further has an abutting surface 32 that abuts against the first elastic portion 782. The abutting surface 32 and the recessed portion 31 are separated. In this embodiment, a step is formed on an end-portion upper surface of the screw holding device 3, and the abutting surface 32 is formed at the bottom of the step. The recessed portion 31 is formed on an end-portion lower surface of the screw holding device 3. Moreover, the screw holding device 3 is further preferably provided with a slope portion 33. The slope portion 33 is disposed between the recessed portion 31 and the abutting surface 32. The function of the slope portion 33 is to facilitate the screw holding device 3 to form good sliding with the pressing block 79 in the process of being installed to the screwdriver 1, so that the pressing block 79 will not affect installation of the screw holding device 3. After the installation is in place, that is, the pressing block 79 cooperates with the recessed portion 31, the slope portion 33 is ineffective. The installation process is as follows: the slope portion 33 of the screw holding device 3 abuts against the pressing block 79, then the screw holding device 3 is driven along a vertical upward direction in this embodiment until the recessed portion 31 cooperates with and is clamped to the pressing block 79, and at this point, the screw holding device 3 is connected to the screwdriver 1. When removal is required, the pressing block 79 is slightly pushed to move to be disconnected from the recessed portion 31, the elastic part 78 elastically drives the screw holding device 3 to move along the vertical upward direction in this embodiment, so as to facilitate the screw holding device 3 to be separated from the screwdriver 1.

In this embodiment, the body 4 includes a front end towards the front side and a rear end towards the rear side. The rear end has two support arms 41 that stretch out towards the rear side. The two support arms 41 are also located on two sides of the work axis X1. One side of each of the support arms 41 towards the work axis X1 is provided with an abutting portion 75 and a cord 77. During assembly, a space formed between the two support arms 41 just accommodates part of the housing 2 of the working end 23 of the screwdriver 1, so that the elastic clamper 71 in the slot 73 on the housing 2 just matches the abutting portion 75 on the support arm 41. Certainly, the support arm 41 may also be provided with a support plate 42 that assists assembly and positioning, and the support plate 42 is used to support the housing 2. In addition, the cord 77 may also be integrally formed with the support arm 41 or by formed by two separately machined elements through fixed connection. In order to make machining and manufacturing convenient, one side of the support arm 41 away from the work axis X1 is further provided with a machining hole 43, and the machining hole 43 directly faces the abutting portion 75. A machining tool may enter from the outside via the machining hole 43, so as to form the abutting portion 75 through machining.

As shown in FIG. 1 to FIG. 7, the clamping mechanism 5 is used to clamp the screw 100 located on the work axis X1. The clamping mechanism 5 is located at the longitudinal front end of the body 4 along the work axis X1. Moreover, the clamping mechanism 5 may move and switch between a clamp position where the screw is clamped and a release position where the screw is released. The clamping mechanism 5 includes at least two clamping arms 51. Resultant force of the clamping arms 51 can stably clamp the screw along the work axis X1 well. The number of the clamping arms 51 may be two or more than two. In this embodiment, the number of the clamping arms 51 is two, which are symmetrically disposed along a vertical plane P1 that passes through the work axis X1. The two clamping arms 51 respectively closely abut against a stem portion of the screw 100, and the resultant force acts upon the screw 100 so as to fixedly maintain the screw 100 on the position along the work axis X1. In this embodiment, the clamping arms 51 are disposed in an L shape. The clamping arms 51 have a mating portion 52 extending along the work axis X1 and a clamping portion 53 perpendicular to the mating portion 52. The mating portion 52 deviates from the work axis X1, so that the space occupied by the mating portion 52 will not affect the tool bit 24 located on the work axis X1. One end of the mating portion 52 mates the driving mechanism 6, and the other end is connected with the clamping portion 53. The clamping portion 53 is disposed perpendicular to the work axis X1, and the clamping portion 53 can be integrally formed with the mating portion 52. The position of the clamping portion 53 near the work axis X1 is provided with jaws used to directly contact the screw 100, and the jaws are provided thereon with V-shaped slots. In other embodiments, the clamping mechanism 5 may also be disposed around the work axis X1 and be disposed coplanar with the work axis X1. Two clamping arms of the clamping mechanism 5 are symmetrically disposed about the work axis X1. The clamping mechanism 5 has a clamp position where the screw 100 is clamped and a release position where the clamped screw 100 is released. Under the action of the driving mechanism 6, the clamping mechanism 5 can move and switch between the clamp position and the release position.

As shown in FIG. 4 to FIG. 7, the driving mechanism 6 includes connection units 61 fixedly connected with the clamping mechanism 5 and guide units 62 that guide the connection units 61 to move. The function of the connection units 61 is to fixedly connect the clamping mechanism 5, to drive the clamping mechanism 5 to move. The number of the connection units 61 is at least two groups, and each group of connection units 61 correspondingly connect one clamping arm 51. In this embodiment, as the number of the clamping arm 51 is two, the number of the connection units 61 is correspondingly two groups. Each group of connection units 61 include at least two connectors. In this embodiment, each connector is a columnar pin that extends along a length direction thereof. One clamping arm 51 is fixedly connected with a first connector 611 and a second connector 612, and the other clamping arm 51 is fixedly connected with a third connector 613 and a fourth connector 614. The first connector 611 and the second connector 612 are located on the same side of the vertical plane P1. The third connector 613 and the fourth connector 614 are located on the other side of the vertical plane P1. The mating portion 52 of the clamping arm 51 is provided thereon with mating holes 54, and the connectors run through the mating holes 54. Moreover, the connectors and the mating holes 54 are in tight fit. In this embodiment, end portions of the connectors mate the mating holes 54. The mating holes 54 are located at one end of the mating portion 52 away from the clamping portion 53. The number of the mating holes 54 is equal to that of the connectors. In this embodiment, the mating portion 52 of the clamping arm 51 has two adjacent mating holes 54, in which one mating hole 54 is used to mate the first connector 611, and the other mating hole 54 is used to mate the second connector 612. It should be noted that a connecting line between the two mating holes 54 and the work axis X1 are not parallel or perpendicular, but are inclined at a certain acute angle. That is to say, the two mating holes 54 are staggered back and forth along the direction of the work axis X1. The first connector 611 and the second connector 612 are disposed in parallel. Under the guiding action of the guide units 62, the first connector 611 and the second connector 612 make respective movement. The first connector 611 is guided to make longitudinal movement and transverse movement perpendicular to the longitudinal direction; while the second connector 612 is guided to at least make longitudinal movement. Certainly, the second connector 612 may also make longitudinal movement and transverse movement. Moreover, the first connector 611 and the second connector 612 are also interchangeable, that is, the first connector 611 is guided to at least make longitudinal movement, and the second connector 612 makes longitudinal movement and transverse movement. Certainly, as the two clamping arms 51 are symmetrically disposed about the vertical plane P1, the other clamping arm 51 is also symmetrically provided with mating holes 54, and the mating holes 54 accommodate the third connector 613 and the fourth connector 614 to pass. The third connector 613 and the fourth connector 614 drive the clamping arm 51 to move. The third connector 613 and the first connector 611 are symmetrically disposed about the vertical plane P1, and the fourth connector 614 and the second connector 612 are symmetrically disposed about the vertical plane P1.

In this embodiment, to guide the first connector 611 to make longitudinal and transverse movement, the guide unit 62 is a first chute 621 located on the body 4. The first connector 611 passes through the first chute 621, so as to make longitudinal and transverse movement under the guiding of the first chute 621. Certainly, in other embodiments, the guide units 62 may also use other structures, as long as they can play a role of guiding. The second connector 612 is also guided to at least make longitudinal movement. The first chute 621 includes an inclined portion 63 inclined relative to the work axis X1, so that the connector 61 cooperates with at least longitudinal movement of the second connector during movement of the inclined portion 63, which changes an included angle between the connecting line between the first connector 611 and the second connector 612 and the longitudinal work axis X1, thus driving the clamping arms 51 to produce pivotal motion to drive the clamping arms 5 to make pivotal motion and linear motion relative to the work axis X1. The inclined portion 63 of the first chute 612 may also be referred to as first inclined portion. During motion, the included angle between the connecting line between the first connector 611 and the second connector 612 and the work axis X1 changes, driving the clamping arms 51 to produce pivotal motion. On the other hand, movement of the first connector 611 in the first chute 621 also drives the clamping arms 51 to make linear motion along the direction of the work axis X1. Therefore, the motion that the clamping arms 51 actually exhibit is compound motion mixed with pivotal motion and linear motion.

In addition to the inclined portion 63, the first chute 621 further includes an extending portion 68 that extends along the direction of the work axis X1. The extending portion 68 connects one end of the inclined portion 63, so that the extending portion 68 is in communication with the inclined portion 63, while the first connector 611 can move between the extending portion 68 and the inclined portion 63. The benefit of setting the extending portion 68 is to make the clamping arms 51, when clamping the screw, not clamp the front end of the screw to clamp nothing. The extending portion 68 of the first chute 621 may also be referred to as first extending portion. As the screw holding device 3 of the present invention is compact-sized, when the screw is installed to the tool bit, a longitudinal distance from the screw to the body 4 is smaller, and in order that the clamping arms 51 can smoothly clamp the screw, the clamping arms 51 need to move backwards longitudinally. Therefore, through movement of the first connector 611 in the extending portion 68, the clamping arms 51 can be driven to move backwards longitudinally, so that a longitudinal distance from the clamping arms 51 to the body 4 is less than the longitudinal distance from the screw to the body 4. In this embodiment, the inclined portion 63 is preferably designed as an inclined straight slot, so that an inclination angle between the extending portion 68 and the inclined portion 63 is preferably an acute angle, that is, the included angle ranges between 0-45 degrees. Certainly, the present invention is limited thereto, and the first chute 611 may also be designed as an arc or another curve, as long as it can drive the first connector 611 to make longitudinal and transverse movement.

In a preferred embodiment, the guide unit 62 further includes a second chute 622 that accommodates the second connector 612 to pass. The second chute 622 has an extending portion 68 used to guide the second connector 622 to move. The extending portion of the second chute 622 may also be referred as second extending portion. During movement, while the first connector 611 moves in the first chute 621, the second connector 612 moves in the second chute 622; in this way, the included angle between the connecting line between the first connector 611 and the second connector 612 and the work axis X1 changes quickly, and the pivotal angle of the clamping mechanism 5 is faster correspondingly. In the event of a smaller movement stroke, the clamping mechanism 5 can move between the clamp position and the release position. If the second connector 612 only moves longitudinally, the second chute 622 can be disposed as a longitudinal straight slot or other corresponding structures. If the second connector 622 not only makes longitudinal movement but also makes transverse movement, the second chute 622 is similar to the first chute 621, and also has an inclined portion and an extending portion. Certainly, the second connector 622 may also be disposed as a curved slot. In a preferred embodiment, the second chute 622 includes an extending portion 68 and an inclined portion 63 connected with the extending portion 68, and the inclined portion 63 of the second connector 622 may also be referred to as second inclined portion.

As shown in FIG. 4, the first chute 621 and the second chute 622 are located on the same side of the vertical plane P1 and the first chute 621 is closer to the vertical plane P1, while the second chute 622 is farther from the vertical plane P1. As, in this embodiment, the first chute 621 and the second chute 622 respectively have an inclined portion 63 and an axial extending portion 68, the axial extending portions 68 of the first chute 621 and the second chute 622 are parallel to each other. The inclined portions 63 of the first chute 621 and the second chute 622 are disposed substantially in a splay pattern. Inclination directions of the inclined portion 63 of the first chute 621 and the inclined portion 63 of the second chute 622 are opposite. Moreover, an opening formed between the two inclined portions becomes large towards the longitudinal front end. Specifically, the inclined portion 63 of the first chute 621 is inclined towards a direction close to the vertical plane P1, while the inclined portion 63 of the second chute 622 is inclined towards a direction away from the vertical plane P1. Inclination angles of the inclined portion 63 of the first chute 621 and the inclined portion 63 of the second chute 622 are similar, preferably between 0-30 degrees. In addition, the first chute 621 and the second chute 622 are both disposed on the body 4. Moreover, the inclined portions 63 are all towards the longitudinal front end of the body 4. The inclined portion 63 of the first chute 621 is located at an axial front end of the first chute 621, and the inclined portion 63 of the second chute 622 is also located at an axial front end of the second chute 622. The first chute 612 and the second chute 622 are also staggered back and forth along the direction of the work axis X1. The first chute 612 is closer to the front side, while the second chute 622 is closer to the rear side. When the first connector 611 and the second connector 612 move in the first chute 621 and the second chute 622 respectively, as the inclination directions of the inclined portions of the first chute 621 and the second chute 622 are different, the included angle between the connecting line between the first connector 611 and the second connector 612 and the work axis X1 changes, and the first connector 611 and the second connector 612 are fixedly connected to the clamping arms 51, the first connector 611 and the second connector 612 drive the clamping arms 51 to produce pivotal motion. Further, pivotal center of the pivotal motion is not the first connector 611 or the second connector 612, but the pivotal axis parallel to the first connector 611 is the pivotal center.

In addition, in an embodiment of having the first chute 621 and the second chute 622, the first chute 621 and the second chute 622 can further cooperate to achieve self-locking and positioning of the clamping mechanism 5. As the clamping arms 51 are fixedly connected with the first connector 611 and the second connector 612, the clamping arms 51 is affected by interaction between the first connector 611 and the second connector 612. The first connector 611 is located in the first chute 621, and the second connector 612 is located in the second chute 622. Therefore, the acting force deviating from the inclination direction will be counteracted due to the acting force of the sidewalls of the chutes, so that the connectors will not move in the chutes but are stationary in the chutes, thereby achieving effects of self-locking and positioning, and preventing free sliding. Only an external force that meets a certain condition can make the two connectors move in respective chutes respectively, so as to achieve the aim of unlocking. The acting direction of the external force that meets the condition can be decomposed to extend along slot directions of two chute inclined portions respectively. Inclination directions of the two chute inclined portions are opposite, and thus the acting direction of the external force is basically along the direction of the work axis X1, and an included angle between it and the work axis X1 does not exceed 45 degrees. Preferably, an included angle between the external force that meets the condition and the work axis X1 is 0-30 degrees. In a preferred embodiment, the included angle is 0-15 degrees.

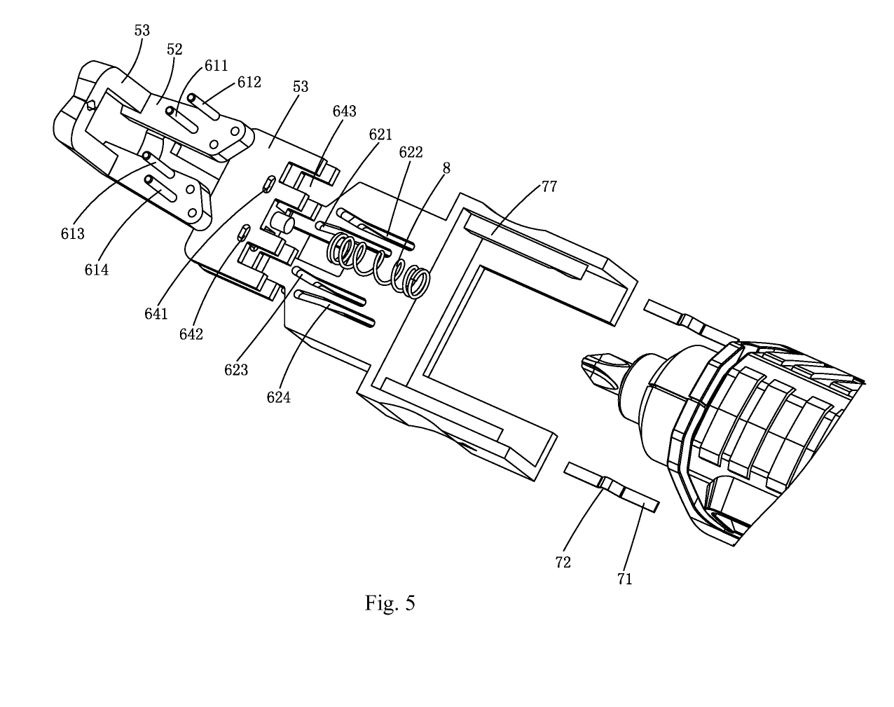

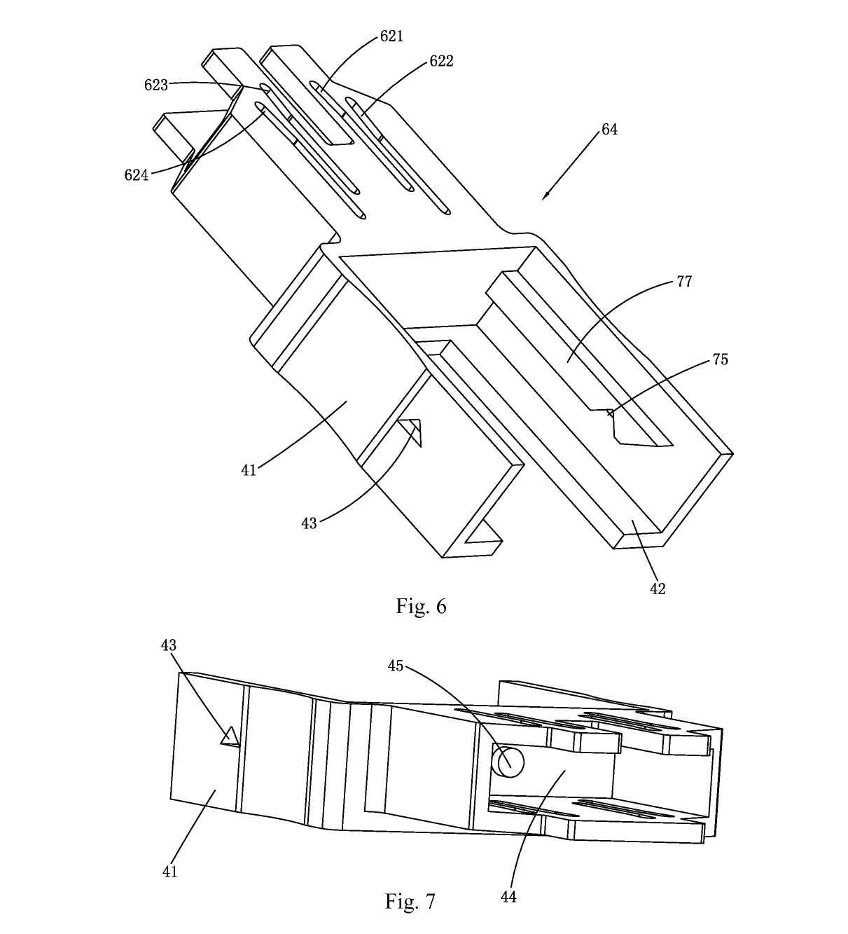

The driving mechanism 6 further includes a moving part 64 movable relative to the body 4. The moving part 64 can only move along the work axis X1 relative to the body 4. Therefore, the moving part 64 produces a limiting effect on the clamping arms 51 through connection of the connector 61. As shown in FIG. 6 and FIG. 7, in this embodiment, the longitudinal front end of the body 4 has an accommodation space to accommodate part of the driving mechanism 6. The moving part 64 is also partially located in the accommodation space. The moving part 64 has a first through hole 641 that accommodates the first connector 611 to pass and a second through hole 642 that accommodates the third connector 613 to pass. The first through hole 641 and the second through hole 642 are symmetrically disposed about the vertical plane P1. Detailed description is given by taking the first connector 611 as an example. An end portion of the first connector 611 mates the mating holes 54 on the clamping arms 51. The middle of the first connector 611 passes through the first through hole 641 and mates therewith. The perforated shape of the first through hole 641 can limit axial movement of the first connector 611. Thus, as shown in FIG. 4, the first through hole 641 is designed as a waist-shaped hole perpendicular to the work axis X1. Hole walls of the waist-shaped hole abut against the first connector 611 along the direction of the work axis X1. The first connector 611 can only move along the length direction of the waist-shaped hole in the waist-shaped hole, that is, a direction perpendicular to the work axis X1. The moving part 64 is further provided thereon with gaps 643 that accommodate the second connector 612 and the fourth connector 614 to pass respectively. The cross sectional area of the gaps 643 are greater and will have no limiting effects on the second connector 612 or the fourth connector 614. In this embodiment, the gaps 643 are openings located in central positions of the moving part 64. In other embodiments, as shown in FIG. 5, the first through hole 641 and the second through hole 642 have limiting effects on the second connector 612 and the fourth connector 614. The first through hole 641 accommodates the second connector 612 to pass, and the second through hole 642 accommodates the fourth connector 614 to pass. The gaps 643 accommodates the first connector 611 and the third connector 613 to pass. In this embodiment, the gaps are notches located at edge positions of the moving part 64. In addition, the moving part 64 includes a two-layer splint structure. Each layer of splint 65 is provided with a through hole and a gap, to accommodate the corresponding connector to pass.

As shown in FIG. 4, the moving part 4 is further connected with an abutting block 67 disposed axially. The main function of the abutting block 67 is to abut against a surface of the workpiece, so as to produce an axial driving force. The abutting block 67 is located at the axial front end of the moving part 64. Preferably, the abutting block 67 is integrally formed with the moving part 64. Moreover, the abutting block 67 is located at a front side of the splint structure. The abutting block 67 is directly located in a space formed between clamping portions 53 of the two clamping arms 51. In an axial direction, compared with the clamping mechanism 5, the abutting block 67 is closer to the axial front end, and a longitudinal distance from a longitudinal front end of the abutting block 67 to a longitudinal rear end of the body 4 is greater than a longitudinal distance from a longitudinal front end of the clamping mechanism 5 to the longitudinal rear end of the body 4. When the screw 100 is driven into the workpiece along the direction of the work axis X1, the abutting block 67 first abuts against the surface of the workpiece. As the driving of the screw goes deep, the abutting block 67 pushes the moving part 64 to move relative to the body 4, so that the clamping mechanism 5 pivots to release the screw. The benefit of such setting is to avoid that the clamping mechanism 5 contacts the surface of the workpiece, thus causing damage to the surface of the workpiece. Certainly, in other embodiments, it is also feasible not to dispose the abutting block 67 and to make the clamping mechanism 5 directly abut against the surface of the workpiece.

The screw holding device 3 further includes a biasing mechanism that biases the moving part 63. The biasing mechanism is a biasing part 8 located between the moving part 64 and the body 4. The biasing part 8 wholly extends along the direction of the work axis X1, thus providing an axial biasing force. One end of the biasing part 8 abuts against the body 4, and the other end abuts against the moving part 64, so as to bias the moving part 64 along the axial direction to move relative to the body 4 at a fixed position. The biasing part 8 is preferably a spring. Certainly, the biasing part 8 may also be in another form such as a magnet. The moving part 64 further includes a guide post 66 used to guide the biasing part 8, in which the guide post 66 is located between a two-layer splint 65, and the guide post 66 is disposed towards the rear side. The front side of the body 4 has an accommodation chamber 44. The accommodation chamber 44 is used to partially accommodate the moving part 64. A guide post 45 is also disposed inside the accommodation chamber 44. The guide post 45 is used to guide the other end of the biasing part 8. The chute 62 is located on a sidewall of the accommodation chamber 44. Moreover, the chute 62 is designed as a through slot, the chute 62 is disposed on opposite sidewalls of the accommodation chamber 44, and the connector 61 runs through the chute on opposite sidewalls of the accommodation chamber. Therefore, during assembly, the first and second connectors pass through the chute 63 on the body 4, the through holes or gaps on the moving part 62 and the mating holes 54 on the clamping arms 51 in sequence. Due to the biasing effect of the biasing part 8, through the axial force provided to the connector 61 by the moving part 64, the connector 61 can be stably maintained at the original position and cannot slide easily.

The working process of the screw holding device 3 is introduced below. As shown in FIG. 1, at this point, the clamping mechanism 5 does not clamp a screw, but the clamping mechanism 5 is still at an extreme position where the screw 100 is clamped. The clamping portions 53 on the two clamping arms 51 of the clamping mechanism 5 fit in with each other. The first connector 61 connected by each clamping arm 51 is respectively located at the inclination portion 63 of the first chute 621. In a preferred embodiment, the second connector 612 is located in the second chute 622. Further, two connectors are located at longitudinal front ends of the chutes. The biasing part 8 axially abuts against the moving part 64, so as to apply a biasing force towards the axial front side to the connector 61, and the first connector 611 is located at the end portion of the inclined portion 63 and is maintained at the position.

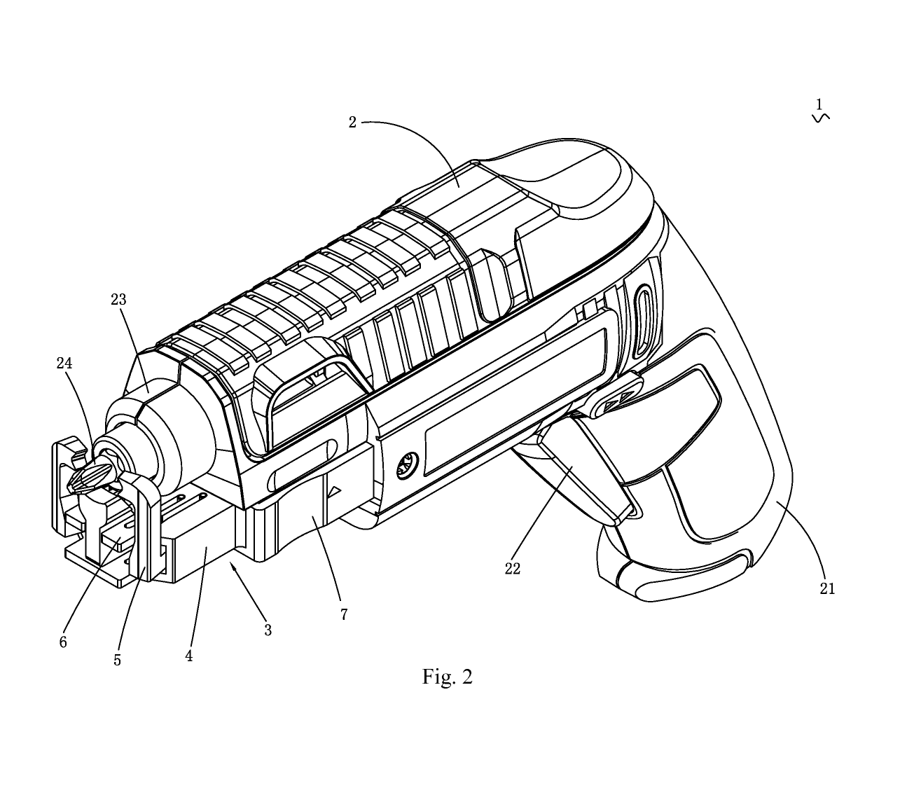

When it is necessary to clamp the screw 100, a user needs to push the clamping mechanism 5 along a direction of an axial outer side. The acting direction of the external force is towards a rear end of a longitudinal axis, so as to play a role of overcoming the biasing force of the biasing part 8. As shown in FIG. 2, after the acting force of the biasing mechanism is overcome, the clamping mechanism 5 pushes the moving part 62 to move in the chute 62. As the first chute 61 has an inclined portion 63 inclined relative to the direction of the longitudinal axis, in the process that the first connector 61 moves in the first chute 611, an included angle between a connecting line direction of the first connector 611 and the second connector 612 and the longitudinal axis changes. The clamping arms 51 fixedly connected with the first connector 611 and the second connector 612 produce pivotal motion. Then, the whole clamping mechanism 5 produces pivotal motion to make the jaws of the two clamping arms 51 relatively away from each other. In addition, during pivoting of the clamping mechanism 5, as the second connector 612 moves in the second chute 622 longitudinally, the clamping mechanism 5 is driven to linearly move towards a longitudinal rear end. In a preferred embodiment, the first chute 621 and the second chute 622 both have an extending slot disposed longitudinally, and after completion of rotation, the first connector 611 and the second connector 612 both move to longitudinal rear ends of the extending slots. At this point, the clamping mechanism 5 moves to the release position where the screw is released. The two clamping arms 51 are at a certain distance, so as to be ready for the following driving of the screw. In this embodiment, it is also feasible not to apply an external force to the clamping mechanism 5. Preferably, an operator can act upon the moving part 64 or on the abutting block 67 connected with the moving part 64. The external force acting upon the component can also overcome the biasing force of the biasing part 8, so as to make the first connector 611 and the second connector 612 move.

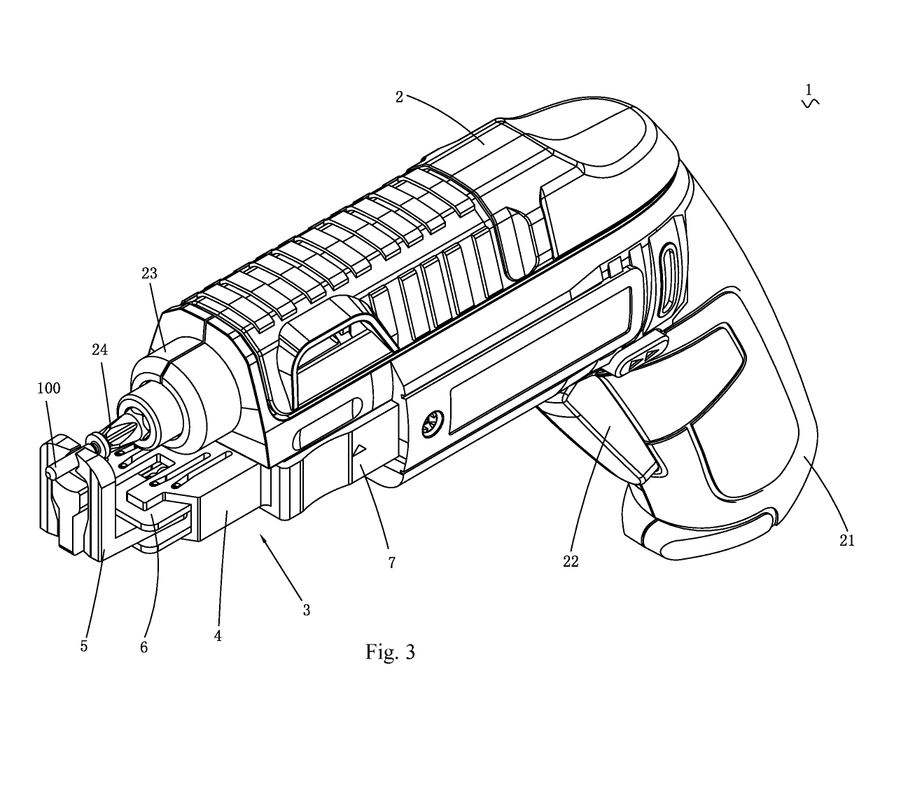

As shown in FIG. 3, after the clamping mechanism 5 is located at the release position, the user can place the screw 100 along the work axis X1 in a relaxed manner, to make the screw 100 contact the tool bit 24. At this point, the external force can be canceled, and under the action of the biasing force of the biasing mechanism, the first connector 611 and the second connector 612 move in the first chute 621 and the second chute 622 respectively. Specifically, moving directions of the first connector 611 and the second connector 612 are directions toward the longitudinal front side. During movement, the clamping mechanism 5 produces pivotal motion, and is reset to the clamp position where the screw is clamped. At this point, the clamping portions 53 of the clamping arms 51 tightly clamp the screw 100 from two sides. It should be noted that, due to existence of the screw 100, the first connector 611 and the second connector 612 will not be reset and move to longitudinal forefronts of their respective chutes.

When the screw 100 is driven into the workpiece, the switch 22 of the screwdriver 1 is turned on, and the screw 100 is driven along the direction of the work axis X1. The tip of the screw 100 first contacts and then enters the interior of the workpiece. With driving of the screw 100, the abutting block 67 begins to contact the surface of the workpiece, and pushes the moving part 64 to overcome the biasing force of the biasing part 8 to move. The moving part 64 drives the clamping mechanism 5 to move axially together through the connector 61. During movement, the clamping mechanism 5 produces pivotal motion, and rotates from the clamp position to the release position where the screw is released. At this point, the screw 100 has been driven into the workpiece. Then, the screwdriver 1 is taken up to make the abutting block 67 out of contact with the surface of the workpiece. After the acting force of the surface of the workpiece thereon is lost, the clamping mechanism 5 is reset to the initial clamp position due to the action of the biasing force of the biasing mechanism, i.e., the clamping mechanism 5 is automatically reset to the initial state. That is, the first connector 611 and the second connector 612 are located at longitudinal front ends of the first chute 611 and the second chute 612 respectively.

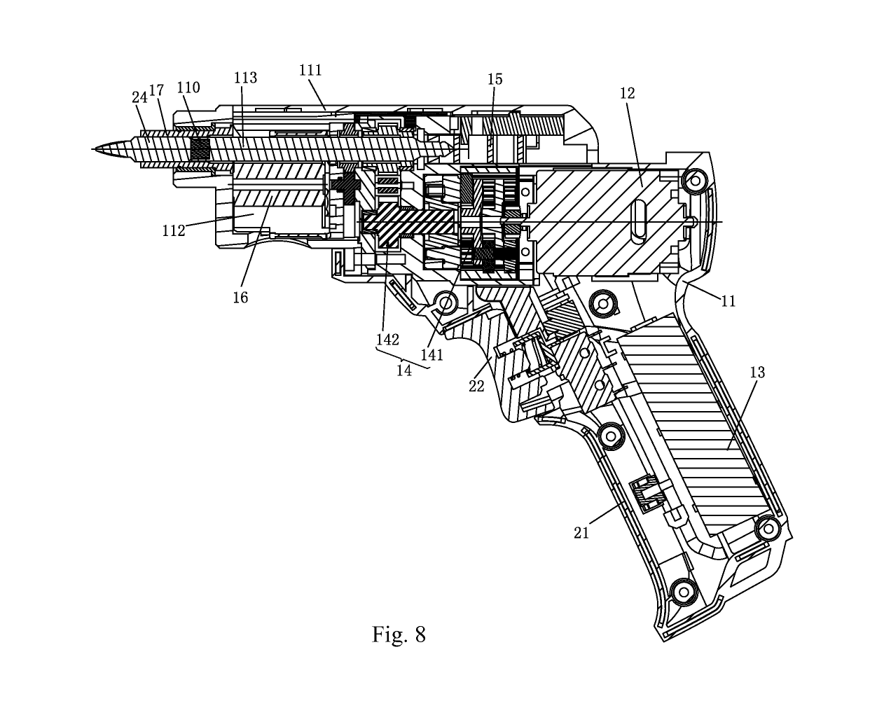

In a preferred embodiment, the screwdriver 1 per se is not a common screwdriver for those skilled in the art, but is a power tool that can achieve storage and rapid change of the tool bit. The power tool 10 is introduced below in detail. As the screw holding device is not changed compared with the one described above, the description thereof is omitted herein. Referring to FIG. 8, the power tool 10 includes a housing 11, a motor 12, a battery pack 13, a transmission mechanism 14, a connecting shaft 15, a cartridge 16, and an output shaft 17. The housing 11 is formed by assembling two half shells in bilateral symmetry through screws (not shown), which has a horizontal part and a handle 21 disposed at an obtuse angle with the horizontal part, preferably, the angle is between 100 degrees to 130 degrees, and operation is relatively comfortable when the handle 21 is held. A switch 22 is disposed on an upper portion of the handle 18, the battery pack 13 is fixed to a rear portion of the handle 21 of the housing 11, and the transmission mechanism 14 is partially fixedly received in the horizontal portion of the housing 11.

The transmission mechanism 14 includes a planetary gear reducing mechanism 141 and a pinion mechanism 142 driven by the motor 12 from back to front (the right side of FIG. 8 is back), in which the pinion mechanism 142 is connected with the connecting shaft 15, and transfers rotary motion of the motor 12 to the output shaft 17 through the connecting shaft 15. The output shaft 17 has an axially-disposed receiving hole that accommodates the tool bit 24. The connecting shaft 15 is disposed in the housing 11, and can make the tool bit 24 at a work position located in the receiving hole or a receiving position located in the cartridge 16. The tool bit herein mainly refers to a slot-type screwdriver bit, a Philip's type screwdriver bit and the like commonly used in electric screw drivers. The cartridge 16 is rotatably supported in the housing 11 and located between the transmission mechanism 14 and the output shaft 17. The cartridge 16 has several receiving spaces, which are used to support multiple tool bits 24, disposed in parallel. By operating the connecting shaft 15 to axially move to pass through the cartridge 16 or leave the cartridge 16, different tool bits 28 can be replaced rapidly when the electric screw driver tightens or releases different screws.

The housing 11 is slidably connected with a slip cover 111, in which the slip cover 111 can drive the connecting shaft 15 to axially move. A part of the cartridge 16 is covered by the slip cover 111, and is exposed with movement of the slip cover 111; the other part is received in the housing 11. In the present invention, preferably, the cartridge 16 is cylindrical and easy to rotate, and occupies a small space, which can certainly be set as square, triangular and the like. During work, the slip cover 111 can close the tool bit cartridge 16, so as to prevent the dust from entering, and when it is necessary to replace the tool bit, the tool bit cartridge 16 can be exposed by removing the slip cover 111, which makes it convenient to select different tool bits.

The output shaft 17 is in a form of a sleeve, generally, the output shaft is set as a hexagonal hole, a tool bit 24 can be installed therein, the cross section of the tool bit is a hexagon matching the hexagonal hole, and the connecting shaft 15 is also a hexagon shaft. In this way, insertion of the connecting shaft 15 into the output shaft 17 can drive the output shaft 17 to rotate, and then the output shaft drives the tool bit 24 to rotate, in this way, a standard tool bit 24 can be used, and it is unnecessary to open a hole that receives the tool bit 24 on the connecting shaft 15, to avoid that the diameter of the connecting shaft 15 is too large and the weight and volume of the whole machine are increased.

The front end of the connecting shaft 15 is provided with a magnet 110, used to adsorb the tool bit 24, when the tool bit 24 is selected, the slip cover 111 can be operated to drive the connecting shaft 15 to pass through a tool bit chamber 112 that receives the tool bit 24, the tool bit 24 is adsorbed by the magnet 110 on the connecting shaft 15, and, under the driving of the connecting shaft 15, leaves the tool bit chamber 112 and enters the output shaft 17. During work, the connecting shaft 15 drives the output shaft 17 to rotate, and the output shaft 17 drives the tool bit 24 to rotate. The slip cover 111 can drive the connecting shaft 15 to move in a manner of connecting a fixed block 113, and when it is necessary to move the connecting shaft 15, limitation to movement of the connecting shaft 15 can be removed by sliding the slip cover 111. Certainly, there are many manners in which the slip cover 111 drives the connecting shaft 15 to move, for example, it is feasible to dispose ring slots round the periphery on the connecting shaft 15, and the slip cover 111 extends into the ring slots through a pin or a steel wire ring to be connected with the connecting shaft 15, which neither affects rotation of the connecting shaft 15 nor affects that the slip cover 111 drives the connecting shaft 15 to move.

Multiple tool bit chambers 112 are evenly distributed on the tool bit cartridge 16 along its circumferential direction, some of the tool bit chambers 112 are closed along an axial direction of the tool bit cartridge 16, and some are open towards an external circumference; in this way, it is convenient for the operator to easily see the shape of the head of the tool bit 24 from the open part when selecting the tool bit 24, so as to rapidly select a desired tool bit 24. After the user operates the slip cover 111 to drive the connecting shaft 15 to leave the tool bit chamber 112 and removes the limitation to the movement of the tool bit cartridge 16, the tool bit cartridge 16 is rotated to a position where next tool bit chamber axially corresponds to the output shaft 17.

The present invention is not limited to the structures of the specific embodiments listed herein, and structures based on the concept of the present invention all fall within the protection scope of the present invention.

1. A screw holding device, configured to assist a screwdriver in holding a screw, the screwdriver configured to provide rotary power output to the screw, the screw holding device comprising:
a body capable of being connected with the screwdriver;
a holder connected with the body, the holder comprising at least two clamping arms being configured to move between a clamp position wherein the screw is clamped and a release position wherein the screw is released; and
a driving mechanism configured to drive the clamping arms;
wherein the driving mechanism comprises a guide unit and a connection unit, the connection unit in correspondence to the clamping arm, the connection unit comprises a first connector and a second connector which are respectively connected with the clamping arm, the guide unit drives the first connector to move longitudinally and laterally, and the guide unit drives the second connector to move at least longitudinally, so as to drive the clamping arms to produce pivotal motion and longitudinal linear motion.

2. The screw holding device according to claim 1, wherein the guide unit comprises a first chute, the first chute comprises a first inclined portion which is inclined relative to the longitudinal direction along a first direction, an angle formed by a line linking the first connector with the second connector and the longitudinal direction is changed by movement of the first connector in the first inclined portion.

3. The screw holding device according to claim 2, wherein the first chute further comprises a first extending portion, first extending portion extends longitudinally and is in communication with the first inclined portion.

4. The screw holding device according to claim 3, wherein the first inclined portion is configured as a straight slot, an inclination angle between the straight slot and the first extending portion is about 0-45 degrees.

5. The screw holding device according to claim 2, wherein the guide unit further comprises a second chute that guides the second connector to move longitudinally.

6. The screw holding device according to claim 5, wherein the second chute comprises a second extending portion which extends longitudinally and a second inclined portion which is in communication with the second extending portion, the second inclined portion is inclined with respect to the longitudinal direction along a second direction which is opposite to the first direction, and an opening formed between the first inclined portion and the second inclined portion, width of the opening becomes larger along the direction towards a longitudinal front end.

7. The screw holding device according to claim 5, wherein the first chute and the second chute are located on the body.

8. The screw holding device according to claim 5, wherein a starting end of the first chute and a starting end of the second chute are spaced apart along the longitudinal axis.

9. The screw holding device according to claim 1, wherein the driving mechanism further comprises a moving part and a biasing mechanism, the moving part has a through hole coupled with the first connector, and the biasing mechanism biases the moving part longitudinally, so that the first connector is movable longitudinally relative to the body.

10. The screw holding device according to claim 9, wherein the biasing mechanism comprises a spring located between the moving part and the body.

11. The screw holding device according to claim 9, wherein the through hole is a waist-shaped hole which is perpendicularly arranged relative to the longitudinal axis.

12. The screw holding device according to claim 9, wherein the driving mechanism further comprises an abutting block connected with the moving part, a first longitudinal distance which is a distance between a longitudinal front end of the abutting block and a longitudinal rear end of the body is larger than a second longitudinal distance which is a distance between a longitudinal front end of the holder and the longitudinal rear end of the body.

13. The screw holding device according to claim 5, wherein the screwdriver defines a vertical plane that passes through the longitudinal axis, the clamping arms comprises a pair of arms which are symmetrically disposed about the vertical plane.

14. The screw holding device according to claim 13, wherein the clamping arms respectively comprise a coupling portion disposed along a longitudinal direction and a holding portion disposed perpendicular to the longitudinal direction, and the coupling portion is provided with a mating hole for fixedly coupling the first connector with the second connector.

15. The screw holding device according to claim 5, wherein the number of the clamping arms is two and the clamping arms are symmetrically disposed about the longitudinal axis.

16. A screwdriver, used to provide rotary power output to a screw, the screwdriver comprising a housing and a motor located in the housing, the motor providing rotary power output, wherein the screwdriver further comprises a screw holding device comprising: a body connected with the screwdriver; a holder connected with the body, the holder comprising at least two clamping arms being configured to move between a clamp position wherein the screw is clamped and a release position wherein the screw is released; and a driving mechanism configured to drive the clamping arms; wherein the driving mechanism comprises a guide unit and a connection unit, the connection unit in correspondence to the clamping arm, the connection unit comprises a first connector and a second connector which are respectively connected with the clamping arm, the guide unit drives the first connector to move longitudinally and laterally, and the guide unit drives the second connector to move at least longitudinally, so as to drive the clamping arms to produce pivotal motion and longitudinal linear motion.

17. The screwdriver according to claim 16, wherein the screw holding device is detachably installed to the housing of the screwdriver through a mating mechanism.

18. The screwdriver according to claim 17, wherein the mating mechanism comprises an elastic coupling element, a slot located in the housing and accommodated with the elastic coupling element, and an abutting portion located in the body, wherein longitudinal movement of the body makes the abutting portion shape matting with the elastic coupling element.

19. The screwdriver according to claim 18, wherein the body and the housing are further respectively provided with a guide portion for guiding the body and the housing to move longitudinally with respect to each other.

20. The screwdriver according to claim 16, wherein the screwdriver comprises an output shaft, a transmission, a tool bit support which is disposed in the housing, and a connecting shaft; the output shaft is provided with a receiving hole disposed axially to accommodate a tool bit; the transmission is configured to transmit rotary power output by the motor to the output shaft; the tool bit support is provided with several chambers arranged in parallel which are used to support the tool bit; and the connecting shaft is capable of making the tool bit to be located at a work position in the chambers or a receiving position in the tool bit support mechanism.

21. The screw holding device according to claim 1, wherein the guide unit drives the first connector to move longitudinally and laterally at the same time, so as to drive the clamping arms to move pivotally.

22. The screwdriver according to claim 16, wherein the screw holding device is detachably connected with the screwdriver.

23. The screwdriver according to claim 17, wherein the mating mechanism comprises an elastic part and a pressing block, the elastic part is located between the housing and the screw holding device and capable of providing an elastic force that biases the screw holding device, and wherein the pressing block abuts against the screw holding device and limits release of the elastic force of the elastic part.

24. The screwdriver according to claim 23, wherein one of the pressing block and the screw holding device is provide with a flange projecting, and the other one of the pressing block and the screw holding device is provided with a recessed portion matched with the flange projecting.
